(19) United States
(12) Patent Application Publication
(10) Pub. No.: US 2005/0055234 A1
(43) Pub. Date: Mar. 10, 2005

(54) DARE Process

(76) Inventors: David S. Larson, San Diego, CA (US); Stuart Schreiber, Del Mar, CA (US)

Correspondence Address: DAVID S. LARSON, SUITE B, 7140 CALABRIA CT., SAN DIEGO, CA, 92122, US

(21) Appl. No.: 10/899,563

(22) Filed: Jul. 27, 2004

Related U.S. Application Data
(60) Provisional application No. 60/490,911, filed on Jul. 29, 2003.

(51) Int. Cl. G06F 17/60

(52) U.S. Cl. 705/1

(57) ABSTRACT

A 4-step method for improving a small business comprising the steps of: 1. Decide A small business owner comes to the realization and makes a conscious decision they need to improve their business and quality of life. Using the first step of the DARE Process, small business owners are asked three questions to see if they're ready to commit to make a positive change in a particular area of their business. 2. Analyze The DARE Process leads small business owners to question and diagnose the specific problems inhibiting the success and/or growth of their business . . . and why?3. Revitalize Through the DARE Process, small business owners develop and initiate new programs designed to re-energize and grow their business, creating new paths to personal freedom. 4. Evaluate Small business owners use the final step of the DARE Process to measure the success of each new initiative. Then, they adjust and fine-tune to constantly stay ahead of their competition.

### PROCESS SUMMARY

The 4-Step DARE Process

The DARE Process is easily applied to any of the five building blocks of any small business: 1) Products and Services; 2) Management; 3) Marketing/Sales; 4) Finance; and, 5) Operations and Manufacturing.

1. Decide

The first and most important step of the DARE Process is to realize you have a problem you need to fix.
You, the small business owner, must make a conscious decision that you need to make a positive change in your business and your life.
You must want to make more money, have more free time, less stress and more fulfilling relationships.
You must decide it's a priority in your life to stay in business, improve your business and as a result, improve the quality of your life.
Your decision must be focused, goal-oriented and committed.
   2. Analyze

Sound business decisions are based on facts not emotion. The DARE Process helps you determine the exact cause of the problems inhibiting the success and growth of your business. A simple, one-page analysis gathers everything you need and points you in the right direction.
Collect all the relevant facts concerning your specific problem.
Diagnose the cause and cost using the DARE Process.
Access all available resources to determine the most cost-effective and business-effective solutions.

3. Revitalize

The DARE Process helps you innovate and initiate new programs to re-energize your business, hitting and exceeding your target goals.
Focus on key areas with one-page templates that contain step-by-step instructions to ensure you don't miss a thing.
Tailor each new initiative to your specific criteria, needs and goals.
Test out a new program before you launch it at full speed.
Communicate with your employees, customers and vendors as needed to keep them abreast of new changes—you need their support to be successful.
Involve your entire business—the most successful programs have the full backing and endorsement from every employee.
   4. Evaluate

One-Page Evaluation Plans go hand-in-hand with your One-Page Revitalization Plans. You've got to know what's working and why. The DARE Process will help you:
Develop a system to accurately measure the success of each new initiative. Quantify where you can . . . numbers don't lie.
Track and Measure with templates provided for your convenience.
Monitory our marketplace, especially your customers. Listen to the heartbeat of your target market. What makes them tick? What do they want next? How can you stay ahead?
Adjust—don't be afraid to change as the results from your evaluation process dictates.

### APPLY THE DARE PROCESS

The DARE Process works across each of the six types of small businesses:
1. Manufacturing
2. Retail
3. Restaurant
4. Auto
5. Service
6. Hospitality

### The DARE Process Flow Chart

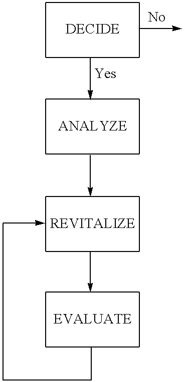

1. The Dare Process is a four-steps method for improving the chances of small business success:
The small business owner follows these 4-steps:
1) Decide you need to do something about it.
2) Analyze the situation by gathering facts and discovering the cause and cost of the problem.
3) Revitalize your business by implementing new programs, products or services.
4) Evaluate the results by using accurate measurement systems and adjust programs as needed.
